(19) United States
(12) Patent Application Publication
(10) Pub. No.: US 2013/0004729 A1
(43) Pub. Date: Jan. 3, 2013

(54) COMPOSITE LAYER

(76) Inventors: Ronald W. Ausen, St. Paul, MN (US); William J. Kopecky, Hudson, WI (US)

(21) Appl. No.: 13/635,701

(22) PCT Filed: Mar. 8, 2011
(86) PCT No.: PCT/US11/27549

§ 371 Date: Sep. 18, 2012

Related U.S. Application Data
(60) Provisional application No. 61/317,490, filed on Mar. 25, 2010.

(51) Int. Cl. B32B 3/10

(52) U.S. Cl. 428/172

(57) ABSTRACT

Composite layer comprising a plurality of first zones of a first polymeric material partially encapsulated in a continuous matrix of a second polymeric material. All first zones of the first polymeric material have an exposed area on only one major surface of the composite layer.

### BACKGROUND

Extrusion of multiple polymeric materials into a single layer or film is known in the art. For example, multiple polymeric flow streams have been combined in a die or feedblock in a layered fashion to provide a multilayer film having multiple layers stacked one on top of the other. It is also known, for example, to provide more complicated extruded film structures where the film is partitioned, not as a stack of layers in the thickness direction, but as stripes disposed side-by-side along the width dimension of the film.

### SUMMARY

For example, co-pending and co-assigned U.S. Pat. Appl. having Ser. 61/221,839, filed Jun. 30, 2009, “Extrusion Die Element, Extrusion Die and Method for Making Multiple Stripe Extrudate from Multilayer Extrudate,” Ausen et al., can produce side-by-side striped films with stripes having widths of 50 mils (1.27 mm) or less. However, some desirable applications would require stripes with a more precise boundary between adjacent stripes.

There is a need for further improvements in such devices for extruding multiple stripe films.

In one aspect, the present disclosure provides a composite layer comprising a plurality of first zones of a first polymeric material partially encapsulated in a continuous matrix of a second polymeric material, wherein all first zones of the first polymeric material have an exposed area on only one major surface of the composite layer. In some embodiments, the second polymeric material has a major surface on the same major surface of the composite layer as the exposed areas of the first zones, and wherein each first zone exposed area has a maximum dimension parallel with said major surface of not greater than 1 mm (in some embodiments, not greater than 0.75 mm, 0.5 mm, 0.25 mm, 0.1 mm, 0.075 mm, 0.05 mm, 0.025 mm, or even not greater than 0.01 mm; in some embodiments, in a range from 0.01 mm to 1 mm, or even from 0.25 mm to 1 mm). In some embodiments, each first zone has a center point, wherein there is a length between two center points separated by a second zone, wherein there is an average of said lengths, where the length (exemplary lengths are shown in FIG. 7 as l₇ and in FIG. 9 as l₉) between two center points separated by a second zone are within 20 (in some embodiments, within 15, 10, or even within 5) percent of the average of said length. In some embodiments, the composite layer has an average thickness as defined between said major surface and a second, generally opposed major surface, and the exposed area of each first zone has a height perpendicular to said major surface, as measured from said major surface, that is at least 5 (in some embodiments, at least 10, 15, 20, 25, 30, 35, 40, 45, 50, 55, 60, 65, 70, 75, 80, 85, 90, 95, or even at least 100) percent of the average thickness of the composite layer. The latter composite layer exhibits ribs. In some embodiments, there are at least 10 (in some embodiments, at least 15, 20, 25, 30, 35, 40, 45, 50, 55, 60, 65, 70, 75, 80, 85, 90, 95, or even at least 100) distinct first zone exposed areas per cm. Measurements of dimensions are determined using an average of 10 random measurements.

Advantages of some embodiments of composite layers described herein are they have relatively precise patterns of first and second polymers and/or at least one relatively small dimension.

### BRIEF DESCRIPTION OF THE DRAWINGS

FIG. 1 is an exploded perspective view of an exemplary embodiment of a set of extrusion die elements for making composite layers described herein, including a plurality of shims, a set of end blocks, bolts for assembling the components, and inlet fittings for the materials to be extruded;

FIG. 2 is a plan view of one of the shims of FIG. 1;

FIG. 3 is a plan view of a different one of the shims of FIG. 1;

FIG. 4 is a perspective partial cutaway detail view of a segment of die slot of the assembled die showing four adjacent shims which together form a different repeating sequence of shims;

FIG. 5 is a cross-section view of a composite layer produced by a die assembled as depicted in FIG. 4, the section line being in the cross-web direction;

FIG. 6 is a perspective partial cutaway detail view of a segment of die slot of the assembled die showing four adjacent shims which together form a different repeating sequence of shims;

FIG. 7 is a cross-section view of a composite layer produced by a die assembled as depicted in FIG. 6, the section line being in the cross-web direction;

FIG. 8 is an exploded perspective view of an alternate exemplary embodiment of an extrusion die, wherein the plurality of shims, a set of end blocks, bolts for assembling the components, and inlet fittings for the materials to be extruded are clamped into a manifold body;

FIG. 9 is a plan view of one of the shims of FIG. 8, and relates to FIG. 8 in the same way FIG. 2 relates to FIG. 1;

FIG. 10 is a plan view of a different one of the shims of FIG. 8, and relates to FIG. 18 in the same way FIG. 3 relates to FIG. 1; and

FIG. 11 is a perspective view of the embodiment of FIG. 8 as assembled.

### DETAILED DESCRIPTION

In some embodiments, extrusion dies used herein comprise a plurality of shims positioned adjacent to one another, the shims together defining a first cavity, a second cavity, and an die slot, wherein the die slot has a distal opening wherein each of the plurality of shims defines a portion of the distal opening, wherein at least a first one of the shims that provides a passageway between the first cavity and the die slot, wherein at least a second one of the shims that provides a passageway between the second cavity and the die slot, and wherein the shims that provide a passageway between the second cavity and the die slot have first and second opposed major surfaces, and wherein the passageway extends from the first major surface to the second major surface.

In some embodiments, extrusion dies used herein comprise a plurality of shims positioned adjacent to one another, the shims together defining a first cavity, a second cavity, and an die slot, wherein the die slot has a distal opening, wherein each of the plurality of shims defines a portion of the distal opening, wherein at least a first one of the shims provides a passageway between the first cavity and the die slot, wherein at least a second one of the shims provides a passageway between the second cavity and the die slot, wherein the shims each have first and second opposed major surfaces and a thickness perpendicular to the major surfaces, and wherein the passageways extend completely through the thickness of the respective shim.

In some embodiments, extrusion dies used herein comprise a plurality of shims positioned adjacent to one another, the shims together defining a first cavity, a second cavity, and an die slot, wherein the die slot has a distal opening, wherein each of the plurality of shims defines a portion of the distal opening, wherein at least a first one of the shims provides a conduit between the first cavity and the die slot, wherein at least a second one of the shims provides a conduit between the second cavity and the die slot, and wherein if a fluid having a viscosity of 300 Pa*s at 220° C. is extruded through the extrusion die, the fluid has a shear rate of less than 2000/sec.

In some embodiments, extrusion dies used herein comprise a plurality of shims positioned adjacent to one another, the shims together defining a first cavity, a second cavity, and an die slot, wherein the die slot has a distal opening, wherein each of the plurality of shims defines a portion of the distal opening, wherein at least a first one of the shims provides a passageway between the first cavity and the die slot, wherein at least a second one of the shims provides a passageway between the second cavity and the die slot, and wherein at least one of the shims is a spacer shim providing no conduit between either the first or the second cavity and the die slot.

In general, a method of making a composite layer described herein comprises:

providing an extrusion die described herein arranged to provide the desired composite layer configuration;

supplying a first extrudable polymeric material into the first cavity;

supplying a second extrudable polymeric material into the second cavity; and

extruding the first and second polymeric materials through the die slot and through the distal opening to provide a composite layer.

In some embodiments a method of making a composite layer described herein comprises:

providing an extrusion die described herein arranged to provide the desired composite layer configuration, the extrusion die comprising a plurality of shims positioned adjacent to one another, the shims together defining a first cavity, a second cavity, and an die slot, wherein the die slot has a distal opening, wherein each of the plurality of shims defines a portion of the distal opening, wherein at least a first one of the shims provides a conduit between the first cavity and the die slot, wherein at least a second one of the shims provides a conduit between the second cavity and the die slot;

supplying a first extrudable polymeric material into the first cavity;

supplying a second extrudable polymeric material into the second cavity; and

extruding the first and second polymeric materials through the die slot and through the distal opening to provide the composite layer comprising at least one distinct region of the first polymeric material and at least one distinct region of the second polymeric material.

Typically, not all of the shims have passageways; some may be spacer shims that provide no conduit between either the first or the second cavity and the die slot. The number of shims providing a passageway between the first cavity and the die slot may be equal or unequal to the number of shims providing a passageway between the second cavity and the die slot.

In some embodiments, extrusion dies described herein include a pair of end blocks for supporting the plurality of shims. In these embodiments it may be convenient for one or all of the shims to each have one or more through-holes for the passage of connectors between the pair of end blocks. Bolts disposed within such through-holes are one convenient expedient for assembling the shims to the end blocks, although the ordinary artisan may perceive other alternatives for assembling the extrusion die. In some embodiments, the at least one end block has an inlet port for introduction of fluid material into one or both of the cavities.

In some embodiments, the shims will be assembled according to a plan that provides a repeating sequence of shims of diverse types. The repeating sequence can have two or more shims per repeat. For a first example, a two-shim repeating sequence could comprise a shim that provides a conduit between the first cavity and the die slot and a shim that provides a conduit between the second cavity and the die slot. For a second example, a four-shim repeating sequence could comprise a shim that provides a conduit between the first cavity and the die slot, a spacer shim, a shim that provides a conduit between the second cavity and the die slot, and a spacer shim.

The shape of the passageways within, for example, a repeating sequence of shims, may be identical or different. For example, in some embodiments, the shims that provide a conduit between the first cavity and the die slot might have a flow restriction compared to the shims that provide a conduit between the second cavity and the die slot. The width of the distal opening within, for example, a repeating sequence of shims, may be identical or different. For example, the portion of the distal opening provided by the shims that provide a conduit between the first cavity and the die slot could be narrower than the portion of the distal opening provided by the shims that provide a conduit between the second cavity and the die slot.

The shape of the die slot within, for example, a repeating sequence of shims, may be identical or different. For example a 4-shim repeating sequence could be employed having a shim that provides a conduit between the first cavity and the die slot, a spacer shim, a shim that provides a conduit between the second cavity and the die slot, and a spacer shim, wherein the shims that provide a conduit between the second cavity and the die slot have a narrowed passage displaced from both edges of the distal opening.

In some embodiments, the assembled shims (conveniently bolted between the end blocks) are further clamped within a manifold body. The manifold body has at least one (or more; usually two) manifold therein, the manifold having an outlet. An expansion seal (e.g., made of copper) is disposed so as to seal the manifold body and the shims, such that the expansion seal defines a portion of at least one of the cavities (in some embodiments, a portion of both the first and second cavities), and such that the expansion seal allows a conduit between the manifold and the cavity.

In some embodiments of dies described herein, the first passageway has a first average length and a first average minor perpendicular dimension, wherein the ratio of the first average length to the first average minor perpendicular dimension is in a range from 200:1 (in some embodiments, 150:1, 100:1, 75:1, 50:1, or even 10:1) to greater than 1:1 (in some embodiments, 2:1) (typically, 50:1 to 2:1), wherein the second passageway has a second average length and a second average minor perpendicular dimension, and wherein the ratio of the second average length to the second average minor perpendicular dimension is in a range from 200:1 (in some embodiments, 150:1, 100:1, 75:1, 50:1, or even 10:1) to greater than 1:1 (in some embodiments, 2:1) (typically, 50:1 to 2:1).

In some embodiments of dies described herein, if a fluid having a viscosity of 300 Pa*s at 220° C. is extruded through the extrusion die, the fluid has a shear rate of less than 2000/sec, wherein the viscosity is determined using a capillary rheometer (available from Rosand Precision Ltd., West Midland, England, under the trade designation “Advanced Rheometer System”; Model RH-2000).

In accordance with another aspect of the present disclosure, a method of making a composite layer is provided, the method comprising: providing an extrusion die comprising a plurality of shims positioned adjacent to one another, the shims together defining a first cavity, a second cavity, and an die slot, wherein the die slot has a distal opening, wherein each of the plurality of shims defines a portion of the distal opening, wherein at least a first one of the shims provides a conduit between the first cavity and the die slot, wherein at least a second one of the shims provides a conduit between the second cavity and the die slot; supplying a first extrudable polymeric material into the first cavity; supplying a second extrudable polymeric material into the second cavity; extruding the first and second polymeric materials through the die slot and through the distal opening to provide the composite layer comprising at least one distinct region of the first polymeric material and at least one distinct region of the second polymeric material. As used in this context, “extrudable polymeric material” refers to polymeric material with 100 percent solids when extruded.

In practicing the method, the first and second polymeric materials might be solidified simply by cooling. This can be conveniently accomplished passively by ambient air, or actively by, for example, quenching the extruded first and second polymeric materials on a chilled surface (e.g., a chilled roll). In some embodiments, the first and/or second polymeric materials are low molecular weight polymers that need to be cross-linked to be solidified, which can be done, for example, by electromagnetic or particle radiation.

In some embodiments, the die distal opening has an aspect ratio of at least 100:1 (in some embodiments, at least 500:1, 1000:1, 2500:1, or even at least to 5000:1).

Methods described herein can be operated at diverse pressure levels, but for many convenient molten polymer operations the first polymeric materials in the first cavities and/or the polymeric materials in the second cavities are kept at a pressure greater than 100 psi (689 kPa). The amount of material being throughput via the first and second cavities may be equal or different. In particular, by volume, the ratio of the first polymeric material passing through the distal opening to the second polymeric material passing through the distal opening can be over 5:1, 10:1, 20:1, 25:1, 50:1, 75:1, or even over 100:1.

The method may be operated over a range of sizes for the die slot. In some embodiments, it may be convenient for the first and second polymeric materials not to remain in contact while unsolidified for longer than necessary. It is possible to operate embodiments of methods of the present disclosure such that the first polymeric material and the second polymeric material contact each other at a distance not greater than 25 mm (in some embodiments, not greater than 20 mm, 15 mm, 10 mm, 5 mm, or even not greater than 1 mm) from the distal opening. The method may be used to prepare a composite layer having a thickness in a range from 0.025 mm to 1 mm.

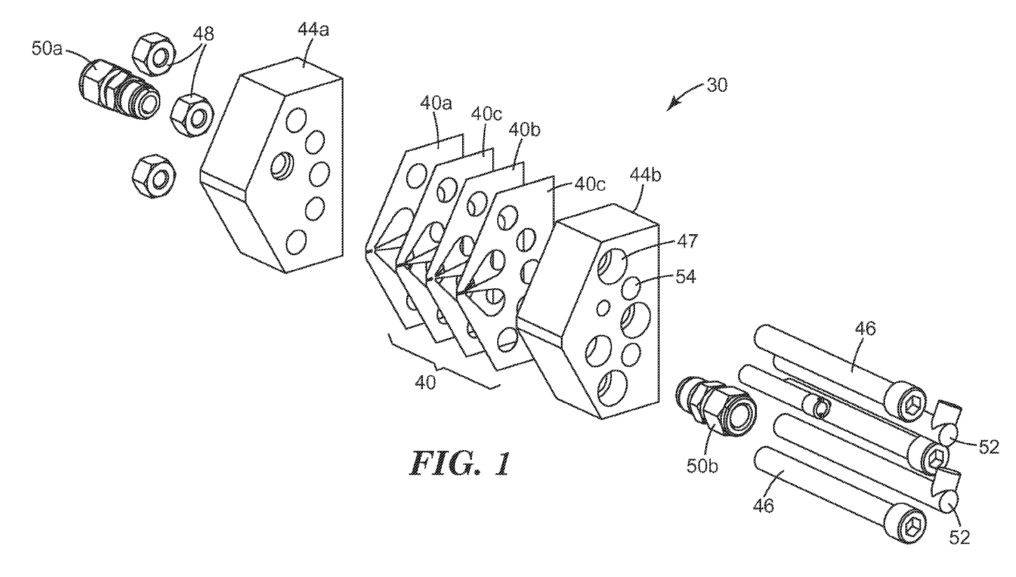

Referring to FIG. 1, an exploded view of an exemplary embodiment of an extrusion die 30 according to the present disclosure is illustrated. Extrusion die 30 includes plurality of shims 40. In some embodiments, there will be a large number of very thin shims 40 (typically several thousand shims; in some embodiments, at least 1000, 2000, 3000, 4000, 5000, 6000, 7000, 8000, 9000, or even at least 10,000), of diverse types (shims 40a, 40b, and 40c), compressed between two end blocks 44a and 44b. Conveniently, fasteners (e.g., through bolts 46 threaded onto nuts 48) are used to assemble the components for extrusion die 30 by passing through holes 47. Inlet fittings 50a and 50b are provided on end blocks 44a and 44b respectively to introduce the materials to be extruded into extrusion die 30. In some embodiments, inlet fittings 50a and 50b are connected to melt trains of conventional type. In some embodiments, cartridge heaters 52 are inserted into receptacles 54 in extrusion die 30 to maintain the materials to be extruded at a desirable temperature while in the die.

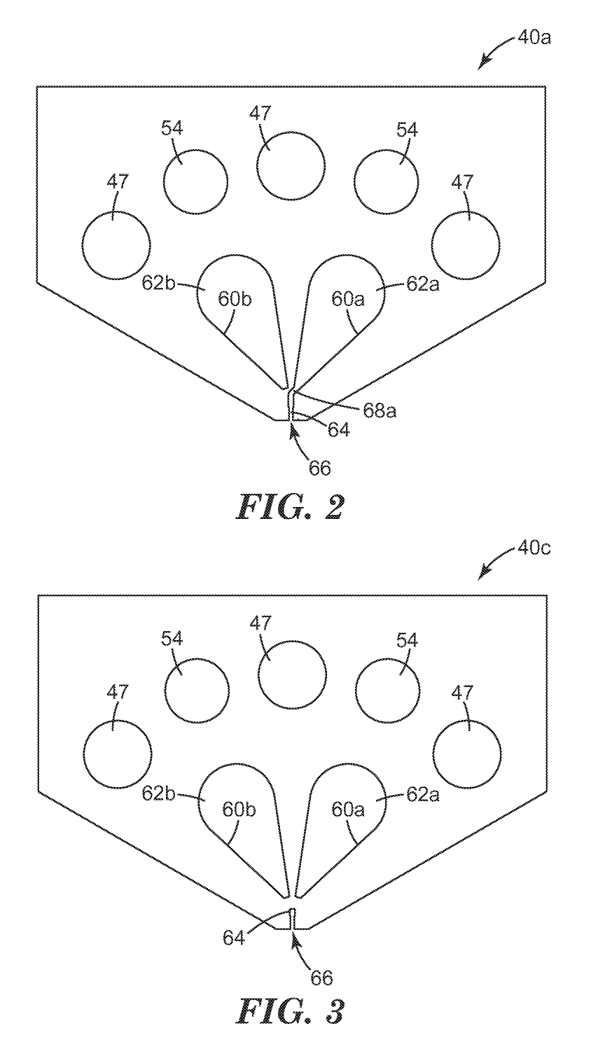

Referring now to FIG. 2, a plan view of shim 40a from FIG. 1 is illustrated. Shim 40a has first aperture 60a and second aperture 60b. When extrusion die 30 is assembled, first apertures 60a in shims 40 together define at least a portion of first cavity 62a. Similarly, second apertures 60b in shims 40 together define at least a portion of second cavity 62b. Material to be extruded conveniently enters first cavity 62a via inlet port 50a, while material to be extruded conveniently enters second cavity 62b via inlet port 50b. Shim 40a has die slot 64 ending in slot 66. Shim 40a further has a passageway 68a affording a conduit between first cavity 62a and die slot 64. In the embodiment of FIG. 1, shim 40b is a reflection of shim 40a, having a passageway instead affording a conduit between second cavity 62b and die slot 64.

Referring now to FIG. 3, a plan view of shim 40c from FIG. 1 is illustrated. Shim 40c has no conduit between either of first or second cavities 62a and 62b, respectively, and die slot 64.

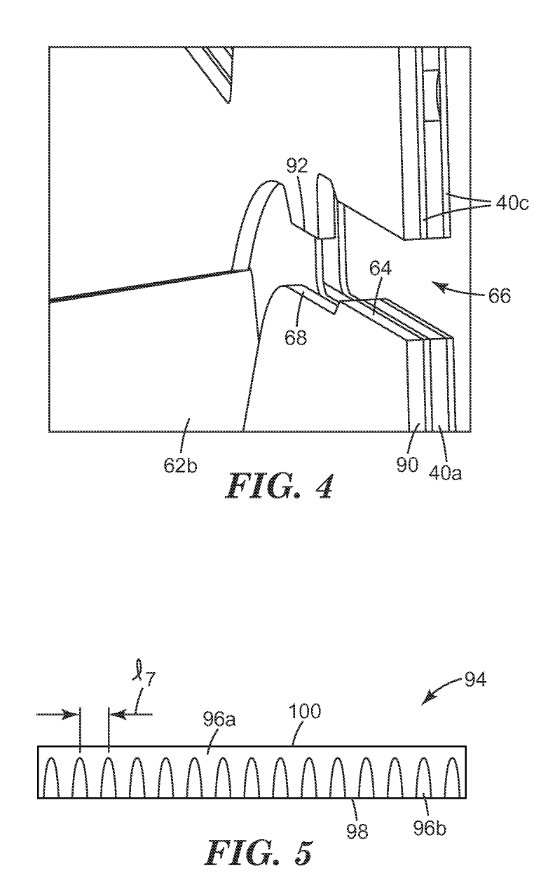

Referring now to FIG. 4, a perspective partial cutaway detail view of a segment of die slot assembled similar to die 30 of FIG. 1 is illustrated. FIG. 4 shows four adjacent shims which together conveniently form a repeating sequence of shims, but in this embodiment shim 40b as shown in sequence in FIG. 1 has been replaced by shim 90. Like shim 40b, shim 90 has passageway 68 which leads to a portion of cavity 62b. However, shim 90 has a flow restriction 92 which reduces the area through which passageway 68 can empty into die slot 64. When a die similar to die 30 is assembled with shims of this type in this way, and two flowable polymer containing compositions are introduced under pressure to cavities 62a and 62b, then co-extruded composite layer generally as depicted in FIG. 5 is produced.

Referring now to FIG. 5, a cross-section view of a composite layer produced by a die assembled as depicted in FIG. 4 is illustrated. Composite layer 94 has repeating vertical regions of material 96b, having been dispensed from cavity 62b. These regions of material 96b are partially enclosed in material 96a, such that areas of material 96b are exposed on first major surface 98 of composite layer 94 and not exposed on second major surface 100 of composite layer 94.

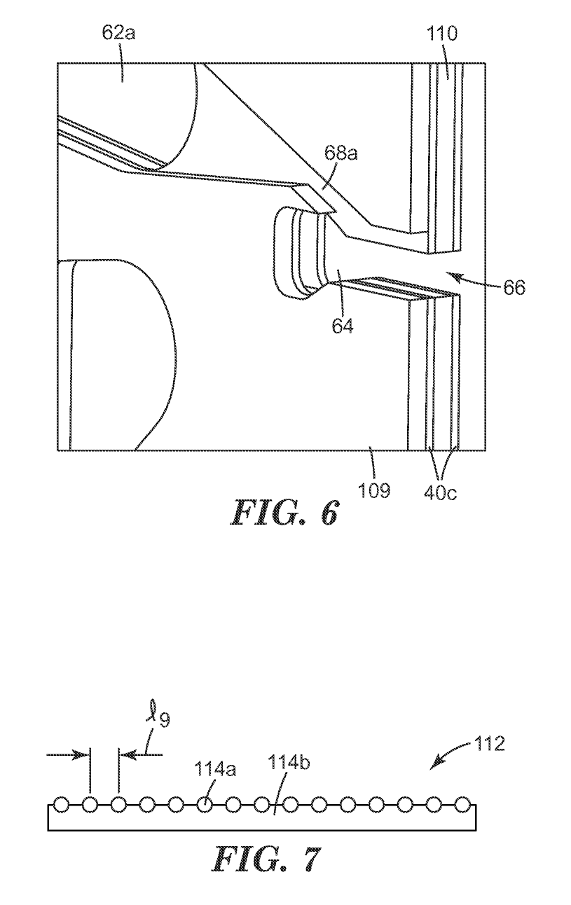

Referring now to FIG. 6, a perspective partial cutaway detail view of a segment of die slot of an assembled die similar to die 30 of FIG. 1 is illustrated. FIG. 6 shows four adjacent shims which together conveniently form a repeating sequence of shims. First in the sequence from left to right as the view is oriented is shim 109. In this view, passageway 68a which leads to a portion of cavity 62a, can be seen. Second in the sequence is spacer shim 40c. Third in the sequence is shim 110. Although not shown in FIG. 6, shim 110 has passageway 68b, leading downwards as the drawing is oriented, providing a conduit with second cavity 62b. Fourth in the sequence is second spacer shim 40c. The embodiment illustrated here stands for the proposition that the slot 66 need not be of equal height for all the shims. As will be noted with more particularity in FIG. 7, described below, the material flowing into first cavity 62a will create a series of ribs 114a extending upward from a surface formed from the material 114b extruded from cavity 62b. When a die similar to die 30 is assembled with shims of this type in this way, and two flowable polymer containing compositions are introduced under pressure to cavities 62a and 62b, then co-extruded composite layer 112, generally as depicted in FIG. 7 is produced.

Referring now to FIG. 7, a cross-section view of a composite layer produced by a die assembled as depicted in FIG. 6 is illustrated. The section line for FIG. 7 is in the cross-web direction of the finished composite layer. Composite layer 112 has repeating regions of material 114a that form ribs on composite layer 114b.

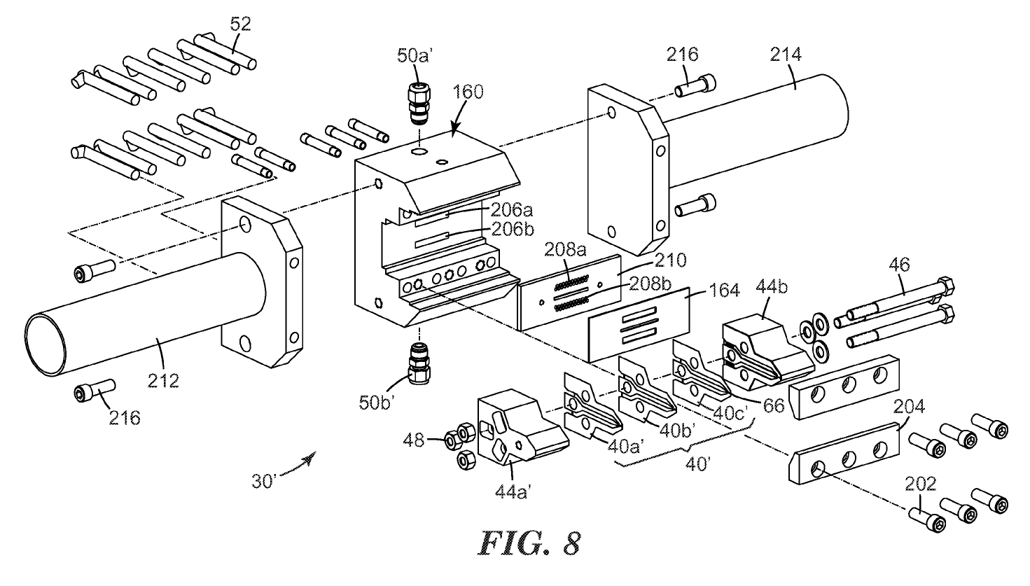

Referring now to FIG. 8, a perspective exploded view of an alternate embodiment of extrusion die 30′ according to the present disclosure is illustrated. Extrusion die 30′ includes plurality of shims 40′. In the depicted embodiment, there are a large number of very thin shims 40′, of diverse types (shims 40a′, 40b′, and 40″c′), compressed between two end blocks 44a′ and 44b′. Conveniently, through bolts 46 and nuts 48 are used to assemble the shims 40′ to the end blocks 44a′ and 44b′.

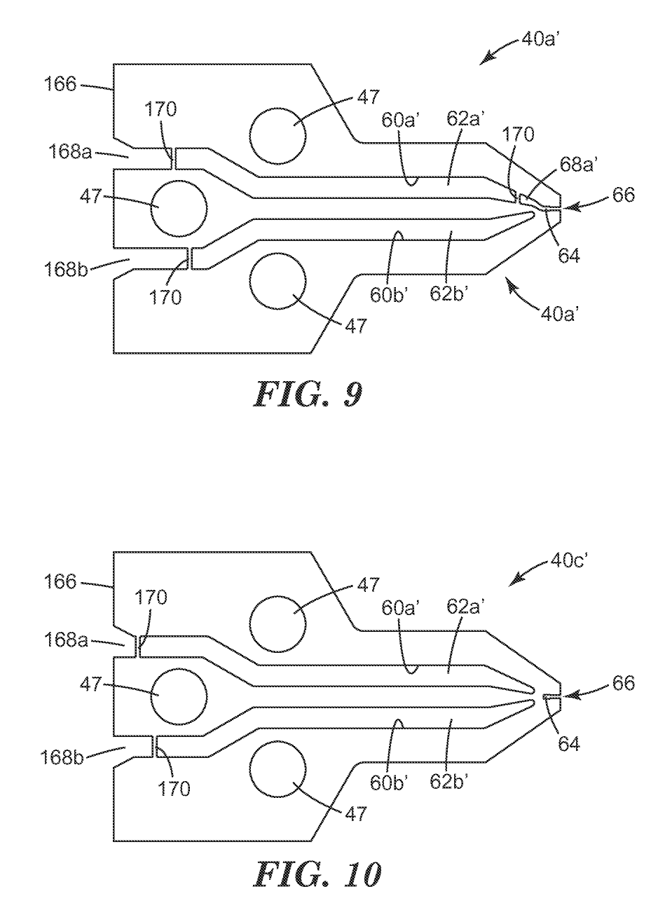

In this embodiment, the end blocks 44a′ and 44b′ are fastened to manifold body 160, by bolts 202 pressing compression blocks 204 against the shims 40′ and the end blocks 44a′ and 44b′. Inlet fittings 50a′ and 50b′ are also attached to manifold body 160. These are in a conduit with two internal manifolds, of which only the exits 206a and 206b are visible in FIG. 8. Molten polymeric material separately entering body 160 via inlet fittings 50a′ and 50b′ pass through the internal manifolds, out the exits 206a and 206b, through passages 208a and 208b in alignment plate 210 and into openings 168a and 168b (seen in FIG. 9).

An expansion seal 164 is disposed between the shims 40′ and the alignment plate 210. Expansion seal 164, along with the shims 40′ together define the volume of the first and the second cavities (62a and 62b in FIG. 9). The expansion seal withstands the high temperatures involved in extruding molten polymer, and seals against the possibly slightly uneven rear surface of the assembled shims 40′. Expansion seal 164 may made from copper, which has a higher thermal expansion constant than the stainless steel conveniently used for both the shims 40′ and the manifold body 160. Another useful expansion seal 164 material includes a polytetrafluoroethylene (PTFE) gasket with silica filler (available from Garlock Sealing Technologies, Palmyra, NY, under the trade designation “GYLON 3500” and “GYLON 3545”).

Cartridge heaters 52 may be inserted into body 160, conveniently into receptacles in the back of manifold body 160 analogous to receptacles 54 in FIG. 1. It is an advantage of the embodiment of FIG. 8 that the cartridge heaters are inserted in the direction perpendicular to slot 66, in that it facilitates heating the die differentially across its width. Manifold body 160 is conveniently gripped for mounting by supports 212 and 214, and is conveniently attached to manifold body 160 by bolts 216.

Referring now to FIG. 9, a plan view of shim 40a′ from FIG. 8 is illustrated. Shim 40a′ has first aperture 60a′ and second aperture 60b′. When extrusion die 30′ is assembled, first apertures 60a′ in shims 40′ together define at least a portion of first cavity 62a′. Similarly, second apertures 60b′ in shims 40′ together define at least a portion of first cavity 62a′. Base end 166 of shim 40a′ contacts expansion seal 164 when extrusion die 30′ is assembled. Material to be extruded conveniently enters first cavity 62a via apertures in expansion seal 164 and via shim opening 168a. Similarly, material to be extruded conveniently enters first cavity 62a via apertures in expansion seal 164 and via shim opening 168a.

Shim 40a′ has die slot 64 ending in slot 66. Shim 40a′ further has passageway 68a′ affording a conduit between first cavity 62a′ and die slot 64. In the embodiment of FIG. 8, shim 40b′ is a reflection of shim 40a′, having a passageway instead affording a conduit between second cavity 62b′ and die slot 64. It might seem that strength members 170 would block the adjacent cavities and passageways, but this is an illusion—the flow has a route in the perpendicular-to-the-plane-of-the-drawing dimension when extrusion die 30′ is completely assembled.

Referring now to FIG. 10, a plan view of shim 40c′ from FIG. 8 is illustrated. Shim 40c′ has no conduit between either of first or the second cavities 62a′ and 62b′, respectfully, and die slot 64.

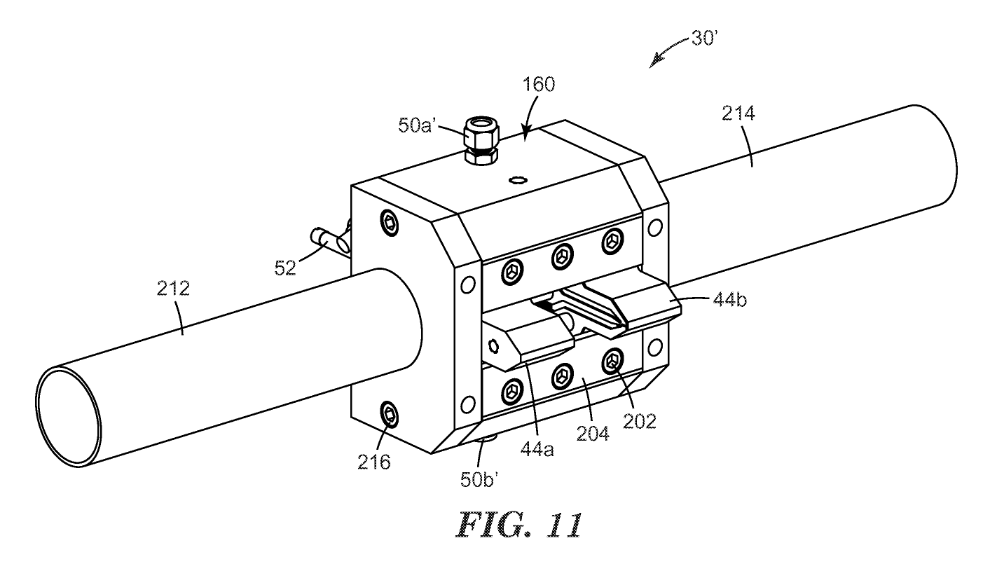

Referring now to FIG. 11, a perspective view of the extrusion die 30′ of FIG. 8 is illustrated in an assembled state, except for most of the shims 40′ which have been omitted to allow the visualization of internal parts. Although the embodiment of FIG. 8 and FIG. 11 is more complicated than the embodiment of FIG. 1, it has several advantages. First, it allows finer control over heating. Second, the use of manifold body 160 allows shims 40′ to be center-fed, increasing side-to-side uniformity in the extruded film. Third, the forwardly protruding shims 40′ allow distal opening 66 to fit into tighter locations on crowded production lines. The shims are typically 0.05 mm (2 mils) to 0.25 mm (10 mils) thick, although other thicknesses, including, for example, those from 0.025 mm (1 mil) to 1 mm (40 mils) may also be useful. Each individual shim is generally of uniform thickness, preferably with less than 0.005 mm (0.2 mil), more preferably, less than 0.0025 mm (0.1 mil) in variability.

The shims are typically metal, preferably stainless steel. To reduce size changes with heat cycling, metal shims are preferably heat-treated.

The shims can be made by conventional techniques, including wire electrical discharge and laser machining Often, a plurality of shims are made at the same time by stacking a plurality of sheets and then creating the desired openings simultaneously. Variability of the flow channels is within 0.025 mm (1 mil), more preferably, within 0.013 mm (0.5 mil).

Suitable polymeric materials for extrusion from dies described herein, methods described herein, and for composite layers described herein include thermoplastic resins comprising polyolefins (e.g., polypropylene and polyethylene), polyvinyl chloride, polystyrene, nylons, polyesters (e.g., polyethylene terephthalate) and copolymers and blends thereof. Suitable polymeric materials for extrusion from dies described herein, methods described herein, and for composite layers described herein also include elastomeric materials (e.g., ABA block copolymers, polyurethanes, polyolefin elastomers, polyurethane elastomers, metallocene polyolefin elastomers, polyamide elastomers, ethylene vinyl acetate elastomers, and polyester elastomers). Exemplary adhesives for extrusion from dies described herein, methods described herein, and for composite layers described herein include acrylate copolymer pressure sensitive adhesives, rubber based adhesives (e.g., those based on natural rubber, polyisobutylene, polybutadiene butyl rubbers, styrene block copolymer rubbers, etc.), adhesives based on silicone polyureas or silicone polyoxamides, polyurethane type adhesives, and poly(vinyl ethyl ether), and copolymers or blends of these. Other desirable materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polyolefins, polyimides, mixtures and/or combinations thereof.

In some embodiments, the first and second polymeric materials each have a different refractive index (i.e., one relatively higher to the other).

In some embodiments, then first and/or second polymeric material comprises a colorant (e.g., pigment and/or dye) for functional (e.g., optical effects) and/or aesthetic purposes (e.g., each has different color/shade). Suitable colorants are those known in the art for use in various polymeric materials. Exemplary colors imparted by the colorant include white, black, red, pink, orange, yellow, green, aqua, purple, and blue. In some embodiments, it is desirable level to have a certain degree of opacity for the first and/or second polymeric material. The type of colorants used and the desired degree of opacity, as well as, for example, the size and shape of the particular zone of the composite article effects the amount of colorant used. The amount of colorant(s) to be used in specific embodiments can be readily determined by those skilled in the (e.g., to achieve desired color, tone, opacity, transmissivity, etc.). If desired the first and second polymeric materials may be formulated to have the same or different colors.

In some embodiments, the first and/or second polymeric materials comprise adhesive material. In some embodiments, the first adhesive material has a first release, and the second adhesive material has a second release, wherein the first and second release have different release properties.

More specifically, for example, for embodiments such as generally shown in FIG. 7, desirable polymers include an acrylate copolymer pressure sensitive adhesive composed of 93% ethyl hexyl acrylate monomer and 7% acrylic acid monomer (made as generally described in U.S. Pat. No. 2,884,126 (Ulrich)) for partially enclosed in material 96a, and a polyethylene polymer (available, for example, from ExxonMobil Chemical Company, Houston, Tex., under the trade designation “EXACT 3024”) for repeating vertical regions 96b. The above polyethylene polymer can also be replaced by another adhesive with lower level of tack. An example include an acrylate copolymer pressure sensitive adhesive composed of 96% hexyl acrylate monomer and 4% acrylic acid monomer so a less tacky adhesive is used for the same repeating vertical regions 96b.

Another acrylate copolymer pressure sensitive adhesive that may be desirable for repeating regions of material 114a is the adhesive used as generally prepared the blown microfiber-acrylate-PSA web (Adhesive 1) in the Examples of U.S. Pat. No. 6,171,985 (Joseph et al), the disclosure of which is incorporated herein by reference, which is an isooctyl acrylate/acrylic acid/styrene macromer copolymer (IOA/AA/Sty, 92/4/4), prepared as generally described in Example 2 of U.S. Pat. No. 5,648,166 (Dunshee), the disclosure of which is incorporated herein by reference.

More specifically, for example, for embodiments such as shown generally in FIG. 9, desirable polymers include an acrylate copolymer pressure sensitive adhesive composed of 93% ethyl hexyl acrylate monomer and 7% acrylic acid monomer (made as generally described in U.S. Pat. No. 2,884,126 (Ulrich) for repeating regions of material 114a, and a polyethylene polymer (available, for example, from ExxonMobil Chemical Company under the trade designation “EXACT 3024”) for ribs 114b. Another acrylate copolymer pressure sensitive adhesive that may be desirable for repeating regions of material 114a is the adhesive used as generally prepared the blown microfiber-acrylate-PSA web (Adhesive 1) in the Examples of U.S. Pat. No. 6,171,985 (Joseph et al), the disclosure of which is incorporated herein by reference, which is an isooctyl acrylate/acrylic acid/styrene macromer copolymer (IOA/AA/Sty, 92/4/4), prepared as generally described in Example 2 of U.S. Pat. No. 5,648,166 (Dunshee), the disclosure of which is incorporated herein by reference.

Exemplary uses for embodiments such as shown generally in FIG. 5 include adhesive tapes employing two different adhesives (i.e., adhesives exhibiting two different adhesion properties) and projection screens.

Exemplary uses for embodiments such as shown generally in FIG. 7 polymers include adhesive tapes and hydrophobic/hydrophilic film constructions.

In some exemplary embodiments employing adhesives, with different adhesive properties (e.g., one has relatively strong adhesive characteristics, and the other relatively weak adhesive characteristics). The type of adhesive functionality could include, for example, the adhesives having the different adhesive properties be tailored together to provide various adhesions to a desire surface (e.g., to skin and/or other articles; good adhesion to plastic (e.g., PVC or other tubing, silicone). The adhesive combinations could also be tailored, for example, to be relatively gentle to skin or to remove a minimal amount of skin cells.

For example, in some exemplary constructions, one adhesive could protrude above another adhesive. For example, again referring to FIG. 7, 114b is a relatively low adhesion adhesive and 114a is a relatively high adhesion adhesive, so a user can handle the composite adhesive article without having the article stick to the hand or gloves. Once the adhesive article is in place on skin, the user can press down the article and have it securely held in place. Alternatively, for example, the adhesive could flow in place once the adhesive has been equilibrated to the same temperature as the skin temperature. The same or similar performance could be provided, for example, when two different adhesives are extruded as generally shown in FIG. 5, wherein 96a is a relatively low adhesion adhesive and 96b is a relatively high adhesion adhesive.

For curable adhesives, curing can be done using conventional techniques (e.g., thermal, UV, heat or electron beam). If the adhesive is cured by electron beam, for example, the acceleration voltage of the beam can also be set up such that the top portion of the adhesive is preferentially cured so the adhesive on the bottom maintains more of its adhesion properties.

### Exemplary Embodiments

1. A composite layer comprising a plurality of first zones of a first polymeric material partially encapsulated in a continuous matrix of a second polymeric material, wherein all first zones of the first polymeric material have an exposed area on only one major surface of the composite layer.
2. The composite layer of exemplary embodiment 1, wherein the second polymeric material has a major surface on the same major surface of the composite layer as the exposed areas of the first zones, and wherein each first zone exposed area has a maximum dimension parallel with said major surface of not greater than 1 mm (optionally, not greater than 0.75 mm, 0.5 mm, 0.25 mm, 0.1 mm, 0.075 mm, 0.05 mm, 0.025 mm, or even not greater than 0.01 mm; optionally, in a range from 0.01 mm to 1 mm, or even from 0.25 mm to 1 mm).
3. The composite layer of either exemplary embodiment 1 or 2, wherein each first zone has a center point, wherein there is a length between two center points separated by a second zone, wherein there is an average of said lengths, where the lengths between two center points separated by a second zone are within 20 (optionally, within 15, 10, or even within 5) percent of the average of said length.
4. The composite layer of any preceding exemplary embodiment, the composite layer has an average thickness as defined between said major surface and a second, generally opposed major surface, and the exposed area of each first zone has a height perpendicular to said major surface, as measured from said major surface, that is at least 5 (optionally, at least 10, 15, 20, 25, 30, 35, 40, 45, 50, 55, 60, 65, 70, 75, 80, 85, 90, 95, or even at least 100) percent of the average thickness of the composite layer.
5. The composite layer of any preceding exemplary embodiment, wherein there are at least 10 (optionally, at least 15, 20, 25, 30, 35, 40, 45, 50, 55, 60, 65, 70, 75, 80, 85, 90, 95, or even at least 100) distinct first zone exposed areas per cm.
6. The composite layer of any preceding exemplary embodiment, wherein, by volume, the ratio of the second polymeric material to the first polymeric material is at least 5:1 (optionally, 10:1, 20:1, 25:1, 50:1, 75:1, or even 100:1).
7. The composite layer of any preceding exemplary embodiment, wherein the first polymeric material comprises first adhesive material.
8. The composite layer of exemplary embodiment 7, wherein the first adhesive material has a first release.
9. The composite layer of any preceding exemplary embodiment, wherein the second polymeric material comprises adhesive material.
10. The composite layer of exemplary embodiment 9, wherein the second adhesive material has a second release.

Advantages and embodiments of this disclosure are further illustrated by the following examples, but the particular materials and amounts thereof recited in these examples, as well as other conditions and details, should not be construed to unduly limit this disclosure. All parts and percentages are by weight unless otherwise indicated.

### EXAMPLE 1

A co-extrusion die as generally depicted in FIG. 1, and assembled with a 4-shim repeating pattern as generally illustrated in FIG. 4, was prepared. The thickness of the shims in the repeat sequence was 5 mils (0.127 mm) for the shims with connection to the first cavity, 5 mils (0.127 mm) for the shims with connection to the second cavity, and 2 mils (0.05 mm) for the spacers which had no connection to either cavity. The shims were formed from stainless steel, with the perforations cut by a numerical control laser cutter.

The inlet fittings on the two end blocks were each connected to a conventional single-screw extruder. A chill roll was positioned adjacent to the distal opening of the co-extrusion die to receive the extruded material. The extruder feeding the first cavity (Polymer A in the Table 1, below) was loaded with polyethylene pellets (obtained under the trade designation “ENGAGE PE 8200” from Dow Corporation).

TABLE 1

| | Example | Example | Example | Example |
|---|---|---|---|---|
| | 1 | 2 | 3 | 4 |
| kg/hr of Polymer A | 2.3 | 1.8 | .45 | 1.2 |
| kg/hr of Polymer B | 1.0 | 0.2 | .15 | .25 |
| Polymer A | 177 | 177 | 80 | 93 |
| Barrel 1 Temp.,° C. | | | | |
| Polymer A | 210 | 204 | 149 | 121 |
| Remaining Barrel | | | | |
| Temp., ° C. | | | | |
| Polymer A Melt Stream | 204 | 204 | 204 | 176 |
| Temp., ° C. | | | | |
| Polymer B | 177 | 185 | 185 | 135 |
| Barrel 1 Temp.,° C. | | | | |
| Polymer B Remaining | 204 | 204 | 204 | 176 |
| Barrel Temp., ° C. | | | | |
| Polymer B Melt Stream | 191 | 204 | 204 | 190 |
| Temp., ° C. | | | | |
| Die Temp., ° C. | 204 | 218 | 204 | 190 |
| Chill roll Temp., ° C. | 27 | 15 | 15 | 15 |
| Chill roll surface speed, | 3 | 6 | 6 | 6 |
| m/min. | | | | |

The extruder feeding the second cavity (Polymer B in the Table 1, above) was loaded with polyethylene pellets (“ENGAGE PE 8200”) and 5% by weight black polypropylene color concentrate (obtained from Clariant Corporation). Other process conditions are listed in Table 1, above. A cross-section of the resulting 0.5 mm (20 mils) thick extruded composite layer is shown in FIG. 5 (Polymer A 96a and Polymer B 96b).

Using an optical microscope, the pitch, l₇,. as shown in FIG. 5 was measured. The results are shown in Table 2, below.

TABLE 2

| | Example 1 | Example 2 |
|---|---|---|
| | l₇, | l₉, |
| Measurement | micrometer | micrometer |
| 1 | 310 | 269 |
| 2 | 306 | 252 |
| 3 | 322 | 273 |
| 4 | 328 | 270 |
| 5 | 328 | 258 |
| 6 | 335 | 265 |
| 7 | 325 | 265 |
| 8 | 325 | 268 |
| 9 | 335 | 262 |
| 10 | 311 | 275 |
| Average of the 10 | 322.5 | 265.7 |
| measurements | | |

### EXAMPLE 2

A co-extrusion die as generally depicted in FIG. 1, and assembled with a 4-shim repeating pattern as generally illustrated in FIG. 6, was prepared. The thickness of the shims in the repeat sequence was 5 mils (0.127 mm) for the shims with connection to the first cavity, 5 mils (0.127 mm) for the shims with connection to the second cavity, and 2 mils (0.05 mm) for the spacers which had no connection to either cavity. The shims were formed from stainless steel, with the perforations cut by a numerical control laser cutter.

The inlet fittings on the two end blocks were each connected to a conventional single-screw extruder. A chill roll was positioned adjacent to the distal opening of the co-extrusion die to receive the extruded material. The extruder feeding the first cavity (Polymer A in the Table 1, above) was loaded with polypropylene pellets (obtained under the trade designation “EXXONMOBIL 1024 PP” from ExxonMobil, Irving, Tex.). The extruder feeding the second cavity (Polymer B in the Table 1, above) was loaded with polypropylene pellets “EXXONMOBIL 1024 PP”) and 10% by weight black polypropylene color concentrate (obtained from Clariant Corporation). Other process conditions are listed in the Table 1, above. A cross-section of the resulting 0.3 mm (12 mils) thick extruded composite layer is shown in FIG. 7 (Polymer A 114b and Polymer B 114a).

Using an optical microscope, the pitch, l₉, as shown in FIG. 7 was measured. The results are shown in Table 2, above.

### EXAMPLE 3

A co-extrusion die as generally depicted in FIG. 1 was assembled with a 10-shim repeating pattern. This 10-shim repeating pattern used shims similar to those illustrated in FIG. 6, but in a different, larger sequence. Referring now to FIG. 6, the 10-shim repeating pattern was: 40a, 40c, 40a, 40c, 40a, 40c, 40a, 40c, 109, and 40c. Similar to Example 2 above, the thickness of the 40a shims in the repeat sequence was 5 mils (0.127 mm), the thickness of the 110 shims was also 5 mils (0.127 mm), and the thickness of the spacer shims 40c was 2 mils (0.05 mm). The shims were formed from stainless steel, with the perforations cut by a numerical control laser cutter.

An acrylate copolymer pressure sensitive adhesive composed of 93% ethyl hexyl acrylate monomer and 7% acrylic acid monomer (made as generally described in U.S. Pat. No. 2,884,126 (Ulrich)) was fed into the first cavity of the die, (polymer A in Table 1). Specifically, the adhesive was pumped into the extruder using an adhesive pump (obtained from Bonnot, Company, Uniontown, Ohio, under the trade designation “2WPKR”), using a heated hose. The temperatures were set at 175° C. for the pump and hose. A polyethylene polymer (obtained from ExxonMobil Chemical Company, Houston Tex., under the trade designation “EXACT 3024”) was fed into the second cavity of the die, (polymer B in Table 1) by a melt train of conventional type.

A chill roll was positioned adjacent to the distal opening of the co-extrusion die, and a 2 mils (0.05 mm) thick polyethylene terephthalate (PET) film with a release coating (obtained from Loparex LLC, Willowbrook, IL, under the trade designation “2.0 CL PET 7340AM”) was conveyed around the chill roll so as to receive the extruded material on the release side. The line speed was adjusted so that a 3 mils (75 micrometers) thick coating was extruded onto the film. Other process conditions are detailed in Table 1, above.

This arrangement of shims produced an extruded composite layer that is solid adhesive on one side and mostly pressure sensitive adhesive broken by regularly spaced polyethylene ribs on the other. The composite layer exhibited a commercially useful low-tack feel. When handled with neoprene gloves, for example, it tended to not stick to the gloves. When placed firmly onto a flexible substrate such as skin, however, it tended to anchor firmly. Matching the flexibility of the backing and the flexibility of the surface to which the pressure sensitive adhesive side is applied should allow tapes to be made with tailored adhesion properties. Adhesion performance can also be tailored for release with use of backings which can be stretched. This enables the user to release the adhesive by stretching the tape backing and the adhesive. An example of a useful backing for such purpose would be a polyester spunlace fabric (available from DuPont, Old Hickory, Tenn., under the trade designation “SOFTESSE 8051”). By aligning the adhesive and polyethylene strands perpendicular to the direction of stretch, there could be created a repeating disruption in the peel front, which would allow the user to remove it from skin with a less degree of trauma.

### EXAMPLE 4

A co-extrusion die as generally depicted in FIG. 1 was assembled with a 12-shim repeating pattern. This 12-shim repeating pattern used shims similar to those illustrated in FIG. 4, but in a different, larger sequence. Referring now to FIG. 4, the 12-shim repeating pattern was: 90, 40c, 90, 40c, 90a, 40c, 40a, 40c, 40a, 40c, 40a, and 40c. The thickness of the “40a” shims in the repeat sequence was 5 mils (0.127 mm), the thickness of the “90” shims was also 5 mils (0.127 mm), and the thickness of the spacer shims “40c” was 2 mils (0.05 mm). The shims were formed from stainless steel, with the perforations cut by a numerical control laser cutter.

An acrylate copolymer pressure sensitive adhesive composed of 93% ethyl hexyl acrylate monomer and 7% acrylic acid monomer (made as generally described in U.S. Pat. No. 2,884,126 (Ulrich)) was fed into the first cavity of the die, (polymer A in Table 1). Specifically, the adhesive was pumped into the extruder using an adhesive pump (“2WPKR”), using a heated hose. The temperatures were set at 175° C. for the pump and hose. A polyethylene polymer (“EXACT 3024”) was fed into the second cavity of the die, (polymer B in Table 1) by a melt train of conventional type.

A chill roll was positioned adjacent to the distal opening of the co-extrusion die, and a 2 mils (0.05 mm) thick polyethylene terephthalate (PET) film with a release coating (“2.0 CL PET 7340AM”) was conveyed around the chill roll so as to receive the extruded material on the release side. The line speed was adjusted so that a 3 mils (75 micrometers) thick coating was extruded onto the film. Other process conditions are detailed in Table 1, above.

The resulting composite layer had some resemblance to the film of FIG. 5, but the surrounded zones were wider and were spaced more widely apart.

Foreseeable modifications and alterations of this disclosure will be apparent to those skilled in the art without departing from the scope and spirit of this disclosure. This disclosure should not be restricted to the embodiments that are set forth in this application for illustrative purposes.

1. A composite layer comprising a plurality of first zones of a first polymeric material partially encapsulated in a continuous matrix of a second polymeric material, wherein all first zones of the first polymeric material have an exposed area on only one major surface of the composite layer, wherein each first zone has a center point, wherein there is a length between two center points separated by a second zone, wherein there is an average of said lengths, and wherein the lengths between two center points separated by a second zone are within 20 percent of the average of said length.

2. The composite layer of claim 1, wherein the second polymeric material has a major surface on the same major surface of the composite layer as the exposed areas of the first zones, and wherein each first zone exposed area has a maximum dimension parallel with said major surface of not greater than 1 mm.

3. (canceled)

4. The composite layer of claim 1, the composite layer has an average thickness as defined between said major surface and a second, generally opposed major surface, and the exposed area of each first zone has a height perpendicular to said major surface, as measured from said major surface, that is at least 5 percent of the average thickness of the composite layer.

5. The composite layer of claim 1, wherein there are at least 10 distinct first zone exposed areas per cm.

6. The composite layer of claim 1, wherein, by volume, the ratio of the second polymeric material to the first polymeric material is at least 5:1.

7. The composite layer of any preceding claim 1, wherein the first polymeric material comprises first adhesive material.

8. The composite layer of claim 7, wherein the first adhesive material has a first release.

9. The composite layer of claim 1, wherein the second polymeric material comprises adhesive material.

10. The composite layer of claim 9, wherein the second adhesive material has a second release.
